(19) United States
(12) Patent Application Publication
(10) Pub. No.: US 2004/0076550 A1
(43) Pub. Date: Apr. 22, 2004

(54) Pipetting device

(76) Inventors: Martin Ruedisser, Jona (CH); Peter Murset, Studen (CH); Nikolaus Ingenhoven, Mannedorf (CH)

Correspondence Address: NOTARO AND MICHALOS, 100 DUTCH HILL ROAD, SUITE 110, ORANGEBURG, NY, 10962-2100, US

(21) Appl. No.: 10/466,504

(22) PCT Filed: Jan. 10, 2002
(86) PCT No.: PCT/CH02/00013

(30) Foreign Application Priority Data
Jan. 25, 2001 (CH) 129/01

(51) Int. Cl. B01L 3/02

(52) U.S. Cl. 422/100

(57) ABSTRACT

The invention relates to an elongate support (1) in which a plurality of pipettes (5) are mounted so that they can be longitudinally displaced and lifted and lowered. The pipette tip (26) is configured to be electroconductive so that, when it is dipped into a liquid, the capacity between the tip and the parts electrically connected to it and other, grounded parts changes and is registered to detect the liquid. To this end, the pipette tip (26) is linked with a circuit (34) in a support (1) via a flexible cable (33). In order to prevent the cable (33) from being caught by movable parts, it is guided, just like the connecting tube (25) of the pipette (5), in a channel of a pipette housing configured as a hollow profile (12) up to the top end thereof and preferably through the interior of a stiffer jacket tube (38) that is configured as a support element and to a C profile (3) of the support (1).

### TECHNICAL AREA

The present invention relates to a pipetting device, as is used in chemical, biological, and medical laboratories.

### RELATED ART

A pipetting device according to the species is known, in which the cable which connects the liquid detector to a control unit runs essentially from the pipette tip to the support. The position of the cables used is poorly controllable in this case, all the more as they usually have little stiffness. This may lead to the cables becoming entangled and interfering with the movements of the different components of the pipetting device, so that additional measures are necessary to avoid such incidents.

### DESCRIPTION OF THE INVENTION

The present invention is based on the object of improving the known pipetting device as simply as possible so that malfunctions due to the cable are prevented. This object is achieved by the present invention as it is distinguished in the characterizing part of Claim 1. Features according to the present invention which lead to refinements result from the dependent claims.

In the pipetting device according to the present invention, the cables are guided in such a way that they are always under control and may not interfere with the cycles. This becomes more important as the movements to which the pipettes are subjected become more complicated.

### BRIEF DESCRIPTION OF THE DRAWINGS

In the following, the present invention is described in greater detail on the basis of figures which merely represent exemplary embodiments.

FIG. 1 shows a side view of a support of a pipetting device according to the present invention, different parts, above all the housing, being at least partially removed,

FIG. 2 shows a section through the support,

FIG. 3 shows an enlarged detail from a section along III-III in FIG. 1,

FIG. 4 shows an enlarged detail from FIG. 3, and

FIG. 5 shows an enlarged detail of a section along V-V in FIG. 3.

### DESCRIPTION OF THE EXEMPLARY EMBODIMENTS

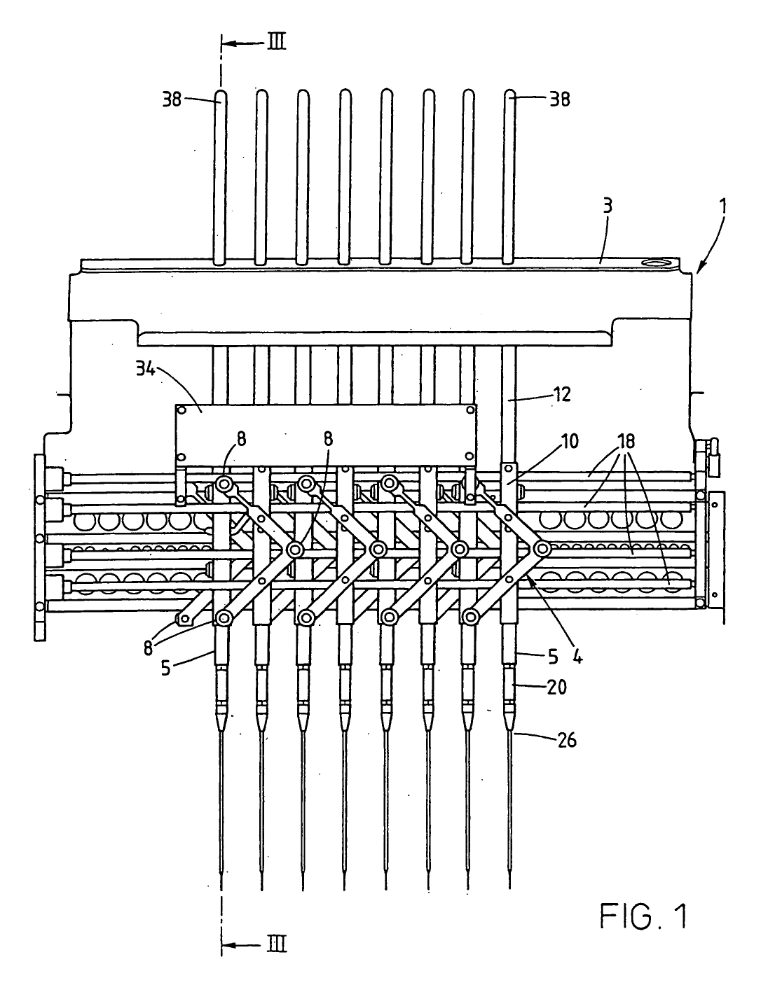

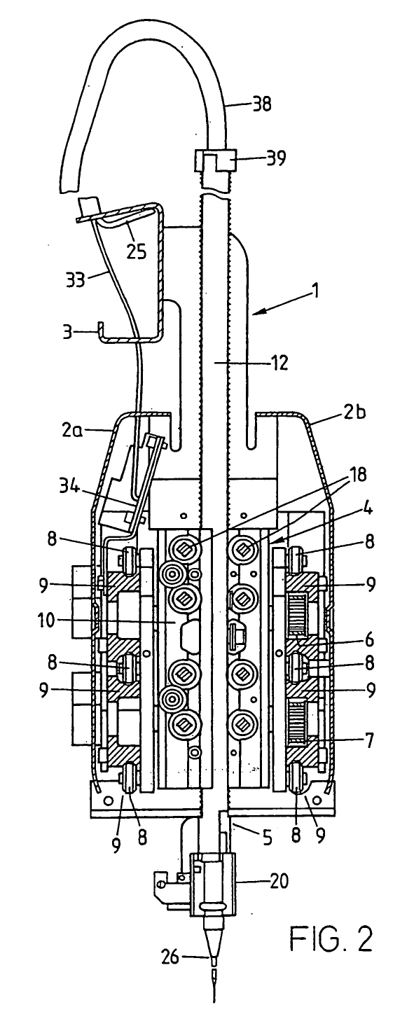

The pipetting device includes (FIGS. 1, 2) an oblong support 1 having a housing, including two shells 2a,b and a C-profile 3, positioned above the shells and connected thereto, which is suspended so it is transversely movable, so that it may be displaced in a controlled way over a working surface on which microtitration plates are positioned, for example. A carriage 4, which carries eight pipettes 5 arranged in a row, is mounted so it is longitudinally movable in support 1. However, more or less pipettes 5 may be positioned in such a row. The carriage 4 may be moved longitudinally in the support 1 through parallel movement of two toothed belts 6, 7, rollers 8, which are positioned on both sides in three rows on top of one another, rolling on rails 9 attached in the housing. However, the carriage may also be stretched and compressed in place through diametrically opposing movement of the toothed belts 6, 7, in such a way that the intervals between neighboring pipettes 5 change in the same way. In this case, the direct driving of those pipettes which are seated at the position 3 and/or 7 (numbered from left to right in FIG. 1) has particularly proven itself, all pipettes being connected to one another using a “Luxembourg grid”, so that their intervals to one another are always essentially equally large—independent of stretching or compression. It has been shown to be especially advantageous if a return spring (not shown) is additionally positioned between the pipettes having the positions 1 and 2. The best reproducibility of the resumption of predetermined pipette intervals is achieved in this embodiment.

Each of the pipettes 5 (see also FIGS. 3, 5) is mounted so it is vertically movable on a holder 10 implemented as a vertical profile and includes a pipette housing, implemented as a vertical hollow profile 12 enclosing a channel 11 which is guided in the holder 10 between two guide arms 13a,b having grooves 14 facing one another, in which ribs 15 of the hollow profile 12 engage. It has continuous outer teeth 16 from the upper end down to near the lower end, in which a drive wheel 17 implemented as a toothed wheel engages. The drive wheel is irrotatably attached to one of a total of eight profiled rods 18, extending over the length of the support 1, which may each be preferably driven individually by a motor (not shown), in such a way that the drive wheel is longitudinally movable, so that it is moved together with the holder 10. The hollow profile 12 may therefore be raised and lowered by rotating the corresponding profiled rod 18, and therefore the drive wheel 17, which engages with its outer teeth 16.

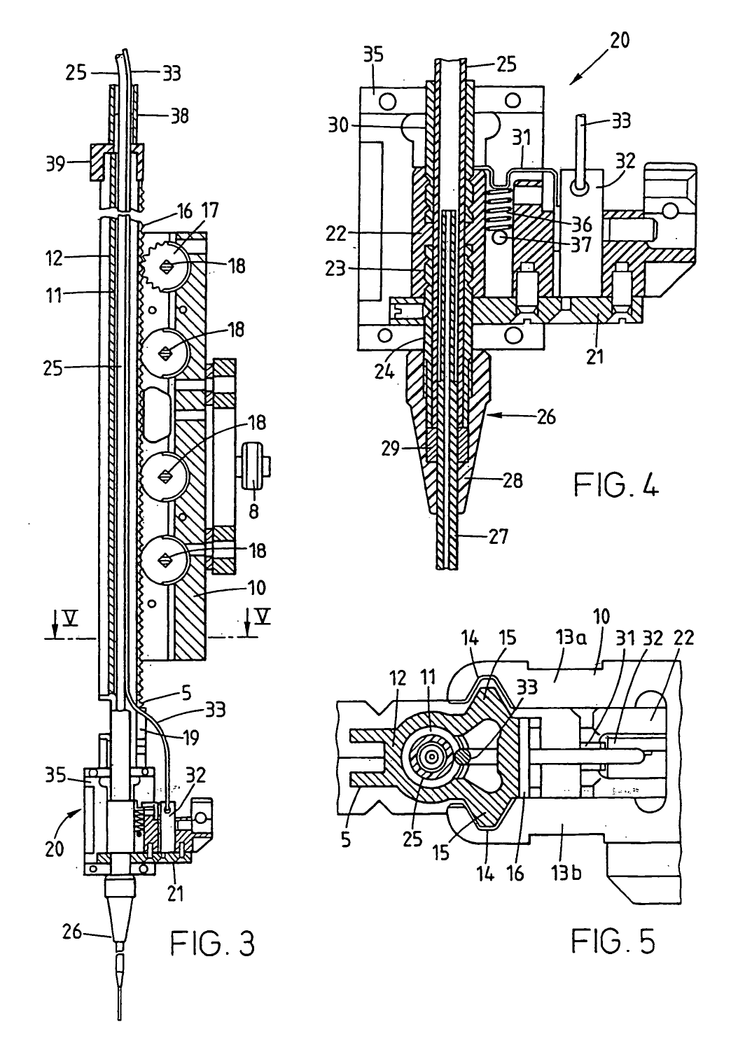

Just above the lower end of the hollow profile 12, the outer teeth 15 end and there is an opening 19 adjoining this, through which the channel 11 is accessible. A pipette head 20 is attached at the lower end of the hollow profile 12, which includes a baseplate 21 made of metal (see FIG. 4), on which a molded part 22 made of an electrically insulating material, preferably plastic, is attached. A vertical continuous channel 23 penetrates both the baseplate 21 and the molded part 22. A lower collar 24 made of metal, which encloses a connection hose 25 made of plastic, is positioned in the lower section of the channel. Both are guided through the baseplate 21 and project out past its bottom side.

A pipette tip 26 is attached to the lower collar 24, having a tube 27 narrowing downward, which projects into the channel 23 inside the connection hose 25, and a conical sleeve 28, which presses against the outside of the lower collar 24, as well as a ring 29, positioned on a recess of the sleeve 28 on the lower end which receives the lower part of the lower collar 24, which is made of an electrically conductive material. The tube 27 is made of electrically conductive plastic or metal and is electrically connected to the baseplate 21 via the ring 29 and the lower collar 24. Above the lower collar 24, the connection hose 25 is enclosed by an upper collar 30 made of metal, whose lower part lies in the channel 23 and which projects into the hollow profile 12.

The upper collar 30 is at an interval to the lower collar 24 and is electrically insulated. It is electrically connected via a bracket 31 to an external contact of a plug 32, which is plugged into a recess of the molded part 22 extending up to baseplate 21. A shielded cable 33 originates from plug 32, which leads to a circuit 34 (FIGS. 1, 2), and whose grounded shielding is electrically connected to the upper collar 30 via the external contact of a plug 32 and the bracket 31, while its core is connected to the baseplate 21 and via the baseplate to the tube 27 of the pipette tip 26. The pipette head 20 also includes a slider 35, movable in a way vertically delimited in relation to the baseplate 21 and the molded part 22, which has a force working downward applied to it by a spiral spring 36, supported on the bracket 31, which presses against a transverse pin 37. However, the slider is held in the position shown by the attached pipette tip 26.

If the pipette tip 26 is lowered into a vessel filled with liquid, such as a cavity of a microtitration plate, as soon as the tip of the tube 27 touches the liquid level, the capacitance suddenly changes between the tip and the part electrically connected to it on one hand and the grounded parts on the other hand, which are connected via the core and/or the shielding of the cable 33 to the circuit 34. This change in capacitance is registered by the circuit 34 to detect the liquid level and may be used to control the pipetting device. For example, the lowering of the corresponding pipette tip may be stopped and suctioning of the liquid may be initiated. If no pipette tip is attached, the slider 35 is in a lower position (not shown), in which the transverse pin 37 rests on the baseplate 21, so, that a short-circuit is produced by the spiral spring 36, which is also registered by the circuit 34.

An elastic sheath hose 38, which is connected to the hollow profile 12 in such a way that it is provided with a vertical initial direction using a connecting sleeve 39, whose further lower part is attached to the hollow profile 12 and over whose narrower upper part the sheath hose 38 is pulled, adjoins the upper end of the hollow profile 12. The sheath hose 38 is guided to the support 1, more precisely to the upper side of the C-profile 3, where its diametrically opposing end is attached. The attachment may also be implemented in such a way that it provides an approximately vertical initial direction to the adjoining section of the sheath hose 38.

The connection hose 25 runs through the channel 11 in the hollow profile 12 and further inside the sheath hose 38 and an opening in the C-profile 3 into its inside, where it is guided to the end of support 1. The cable 33 coming out of the plug 32 is also drawn through the opening 19 in the lower end of the hollow profile 12 into the channel 11, through which it also runs to the upper end of the hollow profile 12 and further inside the sheath hose 38 into the inside of the C-profile 3, from which it is, however, drawn further through further openings into the profile and in the shell 2a to the circuit 34.

The length and the stiffness of the sheath hose 38 are each selected in such a way that it forms a relatively taut curve in any position of the pipette from which it originates, so that it does not obstruct the movements of the pipette but also does not perform any uncontrolled movements itself. The sheath hose 38 is preferably made of plastic. It may be provided with a pronounced spiral structure and/or be reinforced by a braid. The sheath hoses 38 ensure secure and controlled guiding of the cables 33 above all, but also of the connection hoses 25, which may therefore be relatively soft and flexible, and protect the pipetting device from malfunctions which could otherwise be caused through entanglement of cables on other parts. Instead of an sheath hose, other solutions are also conceivable, for example, a support structure implemented in another way and/or a support element implemented in another way, such as an elastic bracket made of plastic, which the cable and the connection hose are attached to at one point or preferably at multiple points or continuously. Finally, it is also conceivable to implement the connection hose itself as relatively stiff and to use it for supporting the softer, more flexible cable. The cable may be attached to the connection hose using hose clamps in this case and/or be wound around it, for example.

In certain circumstances, is sufficient if the cable does not originate from the pipette head 20, but rather from the upper end of the pipette housing. The danger of undesired effects on the movements of other parts of the pipetting device is significantly reduced merely by this.

List of reference numbers

| | |
|---|---|
| 1 | support |
| 2a,b | shells |
| 3 | C-profile |
| 4 | carriage |
| 5 | pipette |
| 6,7 | toothed belts |
| 8 | rollers |
| 9 | rails |
| 10 | holder |
| 11 | channel |
| 12 | hollow profile |
| 13a,b | arms |
| 14 | groove |
| 15 | rib |
| 16 | outer teeth |
| 17 | drive wheel |
| 18 | profiled rod |
| 19 | opening |
| 20 | pipette head |
| 21 | baseplate |
| 22 | molded part |
| 23 | channel |
| 25 24 | lower collar |
| 25 | connection hose |
| 26 | pipette tip |
| 27 | tube |
| 28 | sleeve |
| 30 29 | ring |
| 30 | upper collar |
| 31 | bracket |
| 32 | plug |
| 33 | cable |
| 35 34 | circuit |
| 35 | slider |
| 36 | spiral spring |
| 37 | pin |
| 38 | sheath hose |
| 40 39 | connecting sleeve |

1. A pipetting device having:
at least one support (1), in which a carriage (4) or slide block is mounted and situated so it is displaceable horizontally longitudinally;
at least one pipette (5), suspended on this carriage (4), having an oblong pipette housing, mounted so it is vertically displaceable in the support (1) and in this carriage (4) or slide block, which is implemented as a vertical hollow profile (12), enclosing a channel (11), which is guided in a holder (10) penetrating the carriage (4);
a pipette tip (26) positioned on the lower end of the hollow profile (12);
an electric liquid detector positioned in the region of the pipette tip (26);
a connection hose (25) and a cable (33), which connect the upper end of the pipette tip (26) and/or the liquid detector to the support (1), on which they are attached,
characterized in that an elastic support element adjoins the upper end of the hollow profile (12), which is connected to the hollow profile (12) and the support (1) in such a way that it is provided at both ends with a vertical initial direction, the connection hose (25) and the cable (33) running through the channel (11) in the hollow profile (12) and further along the support element, which at least partially encompasses the connection hose (25) and cable (33), and through an opening in the support (1) into the inside of the support.

2. The pipetting device according to claim 1, characterized in that the pipette housing has outer teeth (16) extending essentially over its height, with which a drive wheel (17), implemented as a toothed wheel, suspended so it is vertically immovable in the carriage (4) and positioned therein, engages, which is positioned so it is not rotatable in relation to a profiled rod (18), which extends essentially over the length of the support (1) and drives the drive wheel (17), but is situated longitudinally movable with the holder (10).

3. The pipetting device according to claim 1 or 2, characterized in that the pipette housing is guided in the holder (10) between two guide arms (13a,b), having grooves (14) facing one another, in which ribs (15) of the hollow profile (12) engage.

4. The pipetting device according to one of claims 1 to 3, characterized in that the support element is flexible, but stiffer than the cable (33), and the length and the stiffness of the support element are each selected so that it forms a relatively taut, freestanding curve between the pipette and support in any position of the pipette from which it originates.

5. The pipetting device according to one of claims 1 to 4, characterized in that the connection hose (25) is also implemented as a support element running from the pipette housing to the support (1), the connection hose (25) and the cable (33) running through the channel (11) in the hollow profile (12) and further essentially parallel to one another and through an opening in the support (1) into the inside of the support.

6. The pipetting device according to claim 5, characterized in that the cable (33) is attached to the connection hose (25) and/or wound around it in the region between the pipette housing and the support (1).

7. The pipetting device according to one of claims 1 to 4, characterized in that it includes a support element, running from the pipette housing to the support (1) and implemented as a bracket, which is flexible but stiffer than the cable (33) and to which the cable (33) and the connection hose (25) are mechanically connected at at least one point between the pipette housing and the support (1).

8. The pipetting device according to one of claims 1 to 4, characterized in that it includes a support element, running from the pipette housing to the support (1) and implemented as an sheath hose (38), the connection hose (25) and the cable (33) running through the channel (11) in the hollow profile (12) and,further inside of the sheath hose (38) and through an opening in the support (1) into the inside of the support.

9. The pipetting device according to claim 8, characterized in that the sheath hose (38) is implemented as stiffer than the connection hose (25).

10. The pipetting device according to one of claims 1 to 9, characterized in that the pipette housing includes a vertical hollow profile (12) having an essentially constant cross-section and a pipette head (20), attached to its lower end, which supports the pipette tip (26) on its lower side.

11. The pipetting device according to one of claims 1 to 10, characterized in that at least the lowermost part of the pipette tip (26) is implemented as electrically conductive and is electrically connected to the cable (33).
